(19) United States
(12) Patent Application Publication
(10) Pub. No.: US 2014/0251820 A1
(43) Pub. Date: Sep. 11, 2014

(54) METHOD OF RECOVERING A METAL FROM A SOLUTION

(71) Applicant: First Solar, Inc., Perrysburg, OH (US)

(72) Inventors: Tim Mays, Perrysburg, OH (US); Matthew Omofoma, Maumee, OH (US); Wenming Wang, Toledo, OH (US)

(21) Appl. No.: 14/199,488

(22) Filed: Mar. 6, 2014

Related U.S. Application Data
(60) Provisional application No. 61/773,233, filed on Mar. 6, 2013.

(51) Int. Cl. C01B 19/02; C25B 1/00; C01B 19/00

(52) U.S. Cl. CPC C01B 19/02; C01B 19/004; C25B 1/00
USPC 205/351; 423/509; 205/615

(57) ABSTRACT

A method for recovering a metal from either an acidic or a basic solution using an aluminum cementation process is disclosed. The method involves adding an aluminum-containing powder to a tellurium-containing solution to precipitate tellurium from the tellurium-containing solution and then removing the precipitated tellurium therefrom.

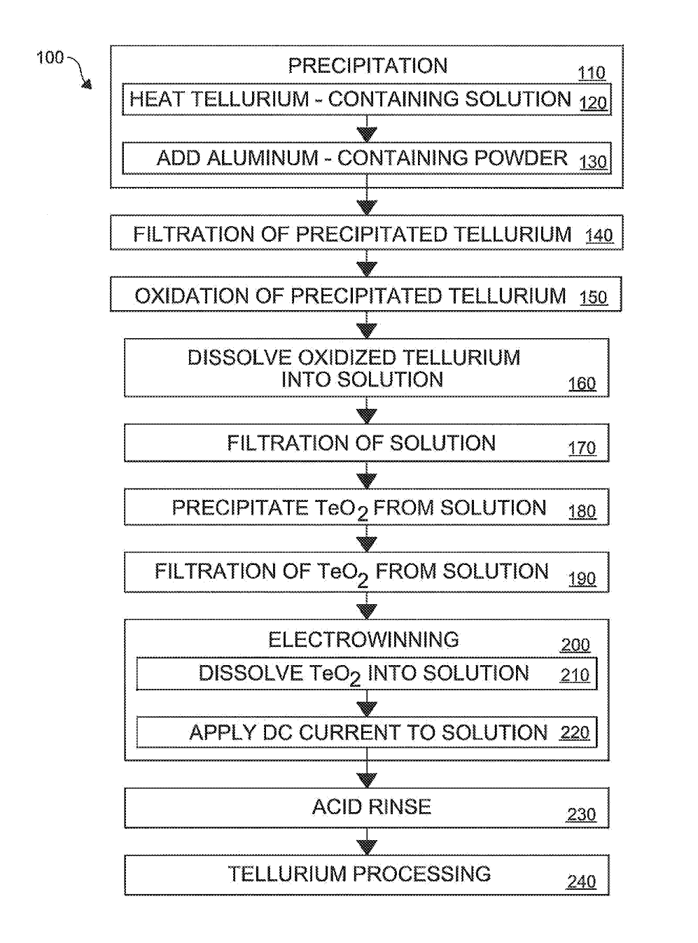

### CROSS-REFERENCE TO A RELATED APPLICATION

This application claims the benefit of priority of U.S. Provisional Patent Application Ser. No. 61/773,233 filed on Mar. 6, 2013 hereby incorporated herein by reference in its entirety.

### FIELD OF THE INVETION

The present disclosure relates to a method of recovering a metal from a solution and, more particularly, to a method for recovering tellurium from an acidic or a caustic solution.

### BACKGROUND OF THE INVENTION

The use of cadmium telluride in photovoltaic modules has increased due to the need to generate renewable, non-polluting, and low cost electricity as an alternative to fossil fuels, However, because the cadmium, cadmium compounds, and tellurium used in the manufacture of thin-film cadmium telluride photovoltaic modules have toxicological properties that make end-of-life disposal of the photovoltaic modules a point of interest. Furthermore, due to the cost and rarity of the tellurium, recovery and reuse of tellurium is desirable.

Methods for recovering cadmium, cadmium compounds, and tellurium from end-of-life photovoltaic modules have been developed to reclaim the metallic materials to militate against polluting the environment caused by disposal of the photovoltaic modules. One such method is disclosed in commonly-owned U.S. Pat. No. 6,129,779 to Bohland et at for RECLAIMING METALLIC MATERIAL FROM AN ARTICLE COMPRISING A NON-METALLIC FRIABLE SUBSTRATE hereby incorporated herein by reference in its entirety. The '779 patent discloses a method of reclaiming a metallic semiconductor material from a non-metallic substrate by crushing the material-coated substrate into a plurality of pieces, and disposing the plurality of pieces in an acidic solution to dissolve the metallic semiconductor material. The plurality of pieces is then removed from the solution and a precipitation agent is added to the acidic solution to precipitate out the metallic materials, thereby recovering the metallic material, such as tellurium.

Known methods of precipitating tellurium from solution include a copper cementation process and the use of sulfur dioxide. Copper cementation is effective in producing a tellurium-containing precipitate with only between about fifteen and forty percent tellurium. Furthermore, copper is only effective as a reducing agent for precipitating tellurium from solution if the solution is acidic. Similarly, use of sulfur dioxide as a reducing agent is inefficient. Sulfur dioxide is not readily soluble in solution, and the process requires specialized ventilation to prevent emission and exposure to the highly-toxic sulfur dioxide. Processes that utilize sulfur dioxide are effective in producing a tellurium-containing precipitate with only about thirty to fifty percent tellurium.

It would be desirable to develop a more efficient method for reclaiming tellurium from solution, and which can be used in either an acidic or a caustic solution.

### SUMMARY OF THE INVENTION

Concordant and congruous with the instant disclosure, a more efficient method for reclaiming tellurium from solution, and which can be used in both caustic and acidic solution, has surprisingly been discovered.

In a first embodiment, a method for recovering tellurium from solution, the method comprising the steps of adding an aluminum-containing powder to a tellurium-containing solution; and precipitating tellurium from the tellurium containing solution.

In another embodiment, a method for recovering tellurium from solution, the method comprising the steps of adding an aluminum-containing powder to a tellurium-containing solution heated to a temperature above about 75° C.; and precipitating tellurium from the tellurium-containing solution.

In another embodiment, a method for recovering tellurium from solution, the method comprising the steps of adding an aluminum-containing powder to a tellurium-containing solution heated to a temperature above about 75° C.; precipitating tellurium from the tellurium-containing solution; filtering the precipitated tellurium from the solution; oxidizing the filtered tellurium in an acidic solution to obtain a slurry containing tetravalent tellurium; dissolving the tetravalent tellurium into a solution by pH adjusting the slurry with a caustic solution until the pH thereof is above about 10.0; precipitating tellurium in the form of TeO2 from the solution by pH adjusting the solution with an acidic solution until the pH thereof is below about 6.0; filtering the precipitated TeO2 from the solution; dissolving the filtered TeO2 in a caustic solution; and electrowinning the dissolved TeO2 to obtain Te.

### DRAWINGS

The above, as well as other advantages of the present disclosure, will become readily apparent to those skilled in the art from the following detailed description, particularly when considered in the light of the drawings described hereafter.

The figure is a flow diagram illustrating a method for reclaiming tellurium from solution according to an embodiment of the invention.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical unless recited otherwise.

As illustrated in the flow diagram of the figure, the present disclosure involves a method 100 of reclaiming a metal from an acidic or a basic solution. The solution may be obtained from a photovoltaic module recycling process as described in the '779 patent or another module recycling process as known in the art. It is understood that the inventive method disclosed herein may be used with solutions obtained from any source. Solutions obtained from photovoltaic module recycling processes may include any number of metals and materials used to manufacture the modules, such as tellurium, cadmium, copper, iron, lead, bismuth, manganese, chromium, other transition metals, and other metals. The method disclosed herein is adapted to recover tellurium having a purity in excess of 99% from such solutions, with a recovery of about ninety-seven percent of the tellurium in solution.

In a precipitating step 110, a tellurium-containing solution is heated to a temperature above about 75° C. in a step 120, The tellurium-containing solution may be heated to any temperature, as desired, such as to a temperature between about 50° C. and about 75° C., to between about 75° C. and about 100° C., to between about 75° C. and about 95° C., or to about 95° C., for example. It has been found that cementation of the tellurium from the tellurium-containing solution takes about 180 minutes at about 75° C., while taking only about 90 minutes at a temperature of about 95° C. In a next step 130, an aluminum-containing powder, such as elemental aluminum, for example, is continuously added to the tellurium-containing solution. It is understood that the aluminum-containing powder may be added at one time, over a period of minutes, or over a period of hours, as desired. The aluminum-containing powder is added to the tellurium-containing solution in a stoichiometric ratio of at least about 0.28 g Al per about 1.0 g Te in solution. Due to the evolution of hydrogen gas by aluminum and hydrogen ion reaction, an amount of aluminum-containing powder in excess of the calculated stoichiometric ratio may be required to remove an optimal amount of tellurium from solution. In one test performed, approximately 2.0 grams of aluminum powder was added into 1.0 liter of tellurium-containing solution having about 430 mg/L tellurium.

As the aluminum-containing powder is added to the tellurium-containing solution, tellurium in the tellurium-containing solution precipitates out of the solution. The precipitate is about seventy-five to about eighty-five perfect tellurium. In a next step 140, the precipitated tellurium is filtered from the solution. The filtered solution may be recycled and reused for additional leaching processes used in photovoltaic module recycling processes. The precipitated tellurium is then washed with water to remove any soluble iron, manganese, cadmium, and/or other impurities therefrom.

In another step 150, the washed tellurium is oxidized to a tetravalent state with an acidic solution, and a tellurium-nitric acid slurry results. The acidic solution may be a nitric acid solution or another acid, as desired. The pH of the slurry is then adjusted in a step 160 by adding a caustic solution, such as a 50% caustic solution, until the pH is greater than 10.0 to dissolve the tetravalent tellurium into solution. The caustic solution may be any caustic solution, such as NaOH, for example. The pH may be adjusted to any pH that results in the tetravalent tellurium dissolving into solution, such as a pH above about 10.5 or above about 11.0 or above about 11.5, for example, as desired. Because manganese, iron, bismuth, and copper are insoluble in caustic solutions, these metals remain solid and are removed from a filtrate in a filtration step 170. The insoluble solids may be washed with water and disposed of in an appropriate manner as waste material.

Tellurium is precipitated from the filtrate in the form of TeO2 in a step 180 by adjusting the pH of the filtrate to below about 6.0 with an acidic solution, such as sulphuric acid or another acidic solution. The pH of the filtrate may be adjusted to below about 5.5 or about 5.0, as desired. The pH may be adjusted to any pH that results in the tellurium precipitating out of the filtrate as TeO2. The TeO2 is removed from the solution in a filtration step 190. The resulting filtrate should contain a sufficiently low enough amount of un-precipitated Te, such as less than about 19 mg/L of tellurium, for example, in solution that the filtrate may be discharged to a waste water plant. The TeO2 undergoes an electrowinning step 200. The electrowinning step 200 involves a step 210 of dissolving the TeO2 into a caustic solution, and a step 220 of applying a DC current to the solution to obtain electrovvon tellurium. The caustic solution may be any caustic solution, such as NaQH, for example. In the electrowinning step 200, any cathode and anode materials may be used, such as stainless steel 304 or stainless steel 316, for example.

The electrowon tellurium is recovered by removing the same from the cathodes. The electrowon tellurium is then rinsed with an acidic solution, such as a 15% HCl solution, for example, to remove residual materials and impurities, such as sodium tellurite in a step 230. Using the method 100 described herein, the overall recovery of tellurium from the tellurium-containing solution has been found to be in excess of ninety-five percent and in some cases about ninety-seven percent. After the HCl rinse step 230, the tellurium may be processed in a subsequent step 240 for use. The processing step 240 may be a step of melting the tellurium in a furnace to about 750° C. The tellurium may be covered with a layer of borax during the melting step in a borax smelting refining step. The melted tellurium may then be cast into ingots for ease of handling and transport. Tellurium ingots formed using the method disclosed herein have been found to have a purity in excess of about 99%, and in some cases to have a purity in excess of about 99.9% and about 99.99%. The tellurium ingots may also undergo additional refining with vacuum distillation.

While certain representative embodiments and details have been shown for purposes of illustrating the invention, it will be apparent to those skilled in the art that various changes may be made without departing from the scope of the disclosure, which is further described in the following appended claims.

What is claimed is:

1. A method for recovering tellurium from solution, the method comprising the steps of:
adding an aluminum-containing powder to a tellurium-containing solution to precipitate tellurium from the tellurium-containing solution.

2. The method of claim 1, wherein the tellurium-containing solution is an acidic solution.

3. The method of claim 1, wherein the tellurium-containing solution is a basic solution.

4. The method of claim 1, further comprising a step of heating the tellurium-containing solution to a temperature above about 75° C. prior to adding the aluminum-containing powder.

5. The method of claim 4, wherein the temperature is about 95° C.

6. The method of claim 1, wherein the aluminum-containing powder is added to the tellurium-containing solution in a stoichiometric ratio of at least about 0.28 g Al per about 1.0 g Te in solution.

7. The method of claim 1, further comprising a step of filtering precipitated tellurium from the solution.

8. The method of claim 7, further comprising a step of oxidizing the filtered tellurium in an acidic solution to obtain a slurry containing tetravalent tellurium.

9. The method of claim 8, further comprising a step of dissolving the tetravalent tellurium into a solution by adjusting the pH of the slurry with a caustic solution until the pH thereof is above about 10.0.

10. The method of claim 9, further comprising a step of filtering the solution to remove undissolved solid impurities.

11. The method of claim 9, further comprising a step of precipitating tellurium in the form of TeO 2 from the solution by adjusting the pH of the solution with an acidic solution until the pH thereof is below about 6.0.

12. The method of claim 11, further comprising a step of filtering the precipitated TeO2 from the solution.

13. The method of claim 12, further comprising a step of dissolving the filtered TeO2 in a caustic solution.

14. The method of claim 13, further comprising a step of applying a DC current to the caustic solution to obtain an electrowon tellurium.

15. The method of claim 14, further comprising a step of removing the electrowon tellurium from the caustic solution and rinsing the same in an acidic solution to remove impurities.

16. The method of claim 15, further comprising a step of melting and casting the rinsed tellurium to obtain tellurium ingots.

17. A method for recovering tellurium from solution, the method comprising the steps of:
adding an aluminum-containing powder to a tellurium-containing solution heated to a temperature above about 75° C.; and
precipitating tellurium from the tellurium-containing solution.

18. The method of claim 17, wherein the tellurium-containing solution is an acidic solution.

19. The method of claim 17, wherein the tellurium-containing solution is a basic solution.

20. A method for recovering tellurium from solution, the method comprising the steps of:
adding an aluminum-containing powder to a tellurium-containing solution heated to a temperature above about 75° C.;
precipitating tellurium from the tellurium-containing solution;
filtering the precipitated tellurium from the solution;
oxidizing the filtered tellurium in an acidic solution to obtain a slurry containing tetravalent tellurium;
dissolving the tetravalent tellurium into a solution by pH adjusting the slurry with a caustic solution until the pH thereof is above about 10.0;
precipitating tellurium in the form of TeO2 from the solution by pH adjusting the solution with an acidic solution until the pH thereof is below about 6.0;
filtering the precipitated TeO2 from the solution;
dissolving the filtered TeO2 in a caustic solution; and
electrowinning the dissolved TeO2 to obtain Te.
